(19) United States
(12) Patent Application Publication
(10) Pub. No.: US 2026/0062257 A1
(43) Pub. Date: Mar. 5, 2026

(54) ANALYSIS DEVICE FOR ANALYZING ELEVATOR OPERATION BY USING NON-INVASIVE ELECTRICAL DATA

(71) Applicant: KUN CHUNG LEE, Taipei City (TW)

(72) Inventor: KUN CHUNG LEE, Taipei City (TW)

(21) Appl. No.: 18/815,882

(22) Filed: Aug. 27, 2024

(51) Int. Cl. B66B 5/00; B66B 1/06; B66B 1/34; B66B 3/00; B66B 13/22

(52) U.S. Cl. CPC B66B 5/0025; B66B 1/06; B66B 1/3461; B66B 3/002; B66B 5/0012; B66B 13/22

(57) ABSTRACT

An analysis device for analyzing an elevator operation by using a non-invasive electrical data, which serves to analyze an operation of a first elevator device. The analysis device includes a first power reader connected to a main wheel driving motor of the first elevator device. The first power reader includes a main wheel current transformer for measuring a single-phase current value and a single-phase voltage value of the main wheel driving motor. The first power reader serves to calculate a plurality of power operation data based on the single-phase current value and the single-phase voltage value. The power operation data include an instantaneous current, an instantaneous voltage, an instantaneous output power and an instantaneous power consumption. The power operation data are outputted to a control processor to be processed.

### FIELD OF THE INVENTION

The present invention is related to a monitoring of an elevator operation, and in particular to an analysis device for analyzing an elevator operation by using a non-invasive electrical data.

### BACKGROUND OF THE INVENTION

Elevator is an important structure in every large building. The power consumption of the elevator is very high due to the high utilization rate of the elevator in a day, and will result in energy waste when the elevator is often in an ineffective operating state. For example, in many buildings (such as department stores or commercial buildings) that have many elevators, the elevators remain in operation during off-peak hours. However, the demand for using elevator during the off-peak hours is relatively low, and it would result in significant energy consumption if all elevators are still open for use.

There are many kinds of elevators having different structures designed by many elevator manufacturers. In prior arts, the operation data of the elevator, such as the running speed, current consumption, voltage and power, and door opening state, are mainly captured by a control box. Therefore, it is very difficult to obtain these operation data without the cooperation of the elevator manufacturer. Moreover, different elevator manufacturers have different control boxes and different control software, it is impossible to design a single device for capturing the data of different control boxes with different control specifications.

Referring to FIG. 7, a traditional elevator device 200′includes an elevator carriage 10′and a driving device 20′for driving the elevator carriage 10′moves upwards and downwards. The driving device 20′includes a driving cable 22′connected to a top side of the elevator carriage 10′and going around a main wheel set 24′. The driving cable 22′is driven by a rotation of the main wheel set 24′to be moved upwards and downwards. The main wheel set 24′is coupled to a center shaft 27′of a main wheel driving motor 26′. The main wheel set 24′is driven by a rotation of the center shaft 27′of the main wheel driving motor 26′. The elevator device 200′further includes a door driving motor 40′for driving a door 100′of the elevator device 200′to open or close the door 100′.

The above components of the elevator device 200′actually contain a lot of current and travel data of the elevator operation, and are also the basic structures that exist in all elevators. Therefore, the operation data of the elevator will be easily obtained if the data are captured in above known components of the elevator device 200′.

### SUMMARY OF THE INVENTION

Accordingly, for improving above mentioned defects in the prior art, the object of the present invention is to provide an analysis device for analyzing an elevator operation by using a non-invasive electrical data, wherein by using the analysis device of the present invention, the manager can realize whether there are passengers in the elevator device during the entire elevator travel, the load of the elevator device, the number of passengers in the elevator device, and so on. The analysis device further performs an analysis to obtain the elevator power consumption and the operation conditions of different elevator. Therefore, the manager can select an appropriate energy saving setting to control the elevator device and can change the elevator operation scheduling, which solves the operation problems during the rush hour, saves the passing time, increases the transportation capacity and saves the power consumption. The analysis device of the present invention is applicable to ESG (Environmental, social, and governance) construction projects.

To achieve above object, the present invention provides an analysis device for analyzing an elevator operation by using a non-invasive electrical data, which serves to analyze an operation of a first elevator device; the analysis device comprising: a first power reader connected to a main wheel driving motor of an elevator carriage of the first elevator device; the main wheel driving motor serving to drive the elevator carriage moves upwards and downwards; the first power reader including a main wheel current transformer for measuring a single-phase current value of a single-phase electric power of the main wheel driving motor and a single-phase voltage value of the single-phase electric power of the main wheel driving motor; the first power reader serving to calculate a plurality of power operation data based on the single-phase current value and the single-phase voltage value; the power operation data including an instantaneous current, an instantaneous voltage, an instantaneous output power and an instantaneous power consumption; the power operation data being outputted to a control processor to be processed; the control processor being connected to the first power reader; and the first power reader being buckled to a wire of the main wheel driving motor.

### BRIEF DESCRIPTION OF THE DRAWINGS

FIG. 1 shows a schematic view of the elevator device of the present invention.

FIG. 2 shows a block diagram of the elements of the present invention.

FIG. 3 shows a block diagram of the energy saving unit of the present invention.

FIG. 4 shows an application of the present invention.

FIG. 5 shows an elevator output power diagram in a normal state of the present invention.

FIG. 6 shows an elevator output power diagram in an abnormal state of the present invention.

FIG. 7 shows a schematic view of the elevator device in the prior art.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

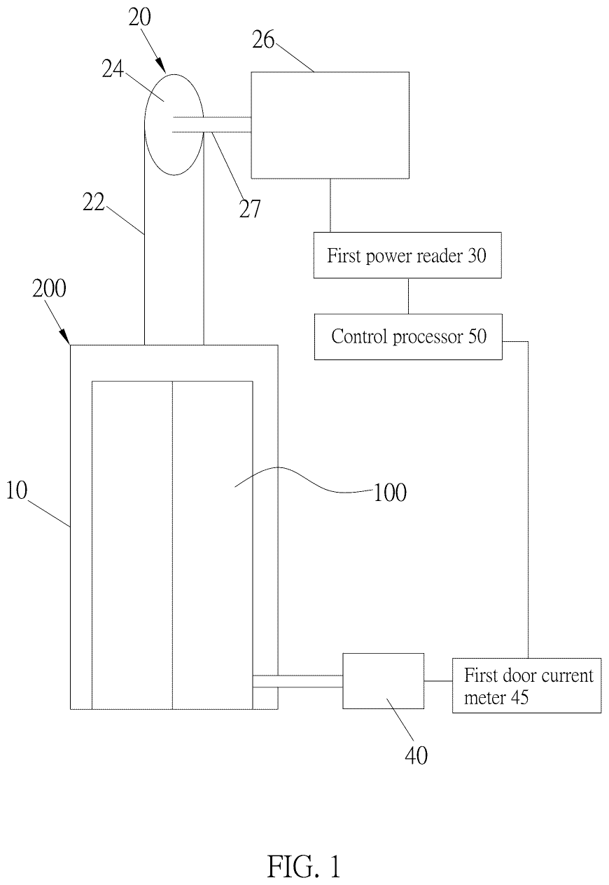

With reference to FIGS. 1 to 6, the present invention provides an analysis device for analyzing an elevator operation by using a non-invasive electrical data, which serves to analyze an operation of a first elevator device 200. The first elevator device 200 includes an elevator carriage 10 and a driving device 20. The driving device 20 is connected to the elevator carriage 10 for driving the elevator carriage 10 moves upwards and downwards. The driving device 20 includes a driving cable 22 connected to a top side of the elevator carriage 10 and going around a main wheel set 24. The driving cable 22 is driven by a rotation of the main wheel set 24 to be moved upwards and downwards. The main wheel set 24 is coupled to a center shaft 27 of a main wheel driving motor 26. The main wheel set 24 is driven by a rotation of the center shaft 27 of the main wheel driving motor 26. Therefore, the main wheel driving motor 26 serves to drive the main wheel set 24 and the driving cable 22 for driving the elevator carriage 10 moves upwards and downwards. The first elevator device 200 further includes a door driving motor 40 for driving a door 100 of the elevator carriage 10 to open or close the door 100.

The analysis device of the present invention comprises the following elements.

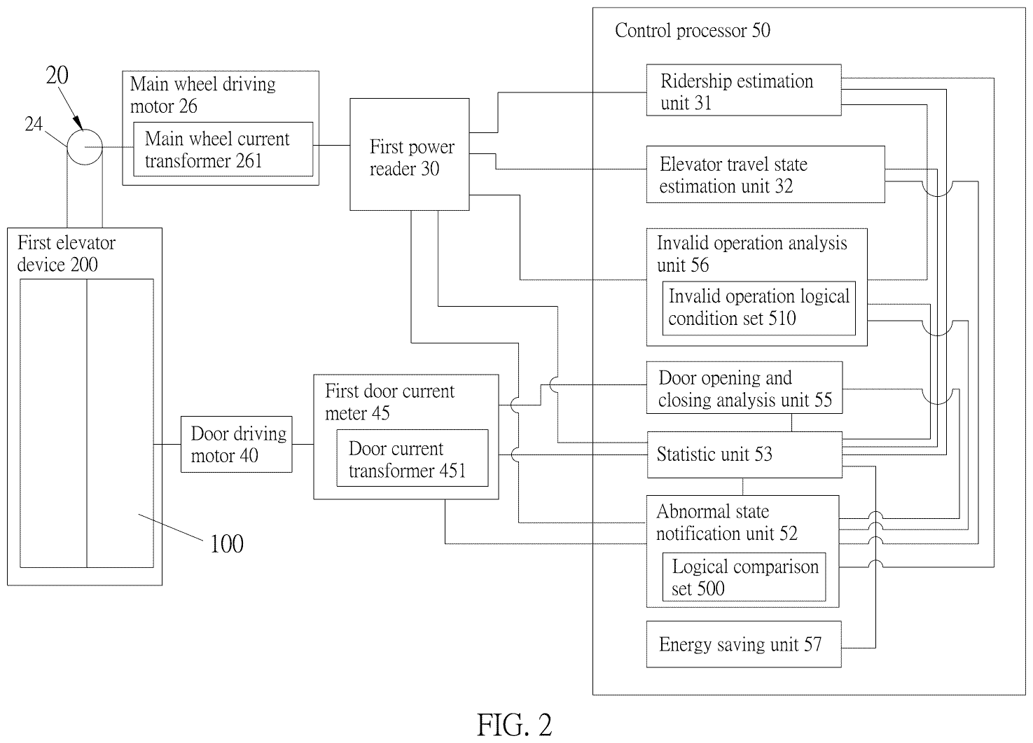

A first power reader 30 is connected to the main wheel driving motor 26. The first power reader 30 includes a main wheel current transformer 261 for measuring a single-phase current value of a single-phase electric power of the main wheel driving motor 26 and a single-phase voltage value of the single-phase electric power of the main wheel driving motor 26. The first power reader 30 serves to calculate a plurality of power operation data based on the single-phase current value and the single-phase voltage value. The power operation data include an instantaneous current, an instantaneous voltage, an instantaneous output power and an instantaneous power consumption. The power operation data are outputted to a control processor 50 to be processed. The control processor 50 is connected to the first power reader 30 (as shown in FIG. 2). The first power reader 30 is buckled to a wire of the main wheel driving motor 26. A fuse with 1A rated current may be installed on the wire of the main wheel driving motor 26, which can be setup easily without affecting the original components of the first elevator device 200.

A first door current meter 45 is connected to the door driving motor 40 and the control processor 50. The first door current meter 45 includes a door current transformer 451 which is installed on a wire of the door driving motor 40 to be measured. The first door current meter 45 serves to measure a door current value data when the door 100 is opened or closed by the door current transformer 451 and to output the door current value data to the control processor 50.

The control processor 50 serves to determining a plurality of operation state data of a first elevator device 200 based on the power operation data and the door current value data. In the present invention, the power operation data and the door current value data form the non-invasive electrical data to be analyzed by the control processor 50.

The instantaneous output power obtained by the first power reader 30 is inputted to the control processor 50 for analyzing the following data.

The control processor 50 includes:
A ridership estimation unit 31 is connected to the first power reader 30 and serves to estimate a number of passengers of the first elevator device 200 based on the instantaneous output power for obtaining a ridership data per run of the first elevator device 200.

An elevator travel state estimation unit 32 is connected to the first power reader 30. Since an increase and a decrease of the instantaneous output power indicates a travel state of the first elevator device 200, the elevator travel state estimation unit 32 serves to calculate speeds, accelerations of the first elevator device 200 at different floors based on a changing of the instantaneous output power to determine a plurality of elevator travel data. The elevator travel data include a running stability of the first elevator device 200, whether the first elevator device 200 is misaligned when it is activated, and whether the first elevator device 200 has a normal braking function. The elevator travel data are outputted to inform a manager of the first elevator device 200 for determining whether the first elevator device 200 requires a maintenance or repair.

An invalid operation analysis unit 56 is connected to the first power reader 30 and the ridership estimation unit 31. The invalid operation analysis unit 56 includes a plurality of invalid operation logical condition sets 510. The power operation data from the first power reader 30 and the ridership of the first elevator device 200 from the ridership estimation unit 31 are inputted to the invalid operation analysis unit 56 for determining an invalid operation data based on the invalid operation logical condition sets 510. The invalid operation data indicates whether there is at least one invalid operation applied to the first elevator device 200. Each of the invalid operation logical condition sets 510 is set by an operation record which is performed by the manager of the first elevator device 200. The invalid operation may be that the door 100 is opened and then is closed when there is no passenger in the first elevator device 200.

The door current value data obtained by the first door current meter 45 is inputted to the control processor 50 for analyzing the following data.

The control processor 50 further includes a door opening and closing analysis unit 55 connected to the first door current meter 45. The door opening and closing analysis unit 55 serves to determine a plurality of door operation data of the door 100 based on the door current value data from the first door current meter 45 for analyzing an opening and closing state of the door 100. The door operation data of the door 100 include an opening condition and a closing condition of the door 100 which are determined by a stability of the door current value data, and an opening time and a closing time of the door 100 which are determined by a flow state of the door current value data. The door operation data is used to determine if the door 100 is operating normally to analyze that if there is an obstruction at the door 100 or there is a passenger caught by the door 100.

The control processor 50 further includes a statistic unit 53 connected to the first power reader 30, the first door current meter 45, the ridership estimation unit 31, the elevator travel state estimation unit 32, the invalid operation analysis unit 56 and the door opening and closing analysis unit 55. The statistic unit 53 serves to calculate a plurality of statistical data based on a plurality of data of the first elevator device 200 from the first power reader 30, the first door current meter 45, the ridership estimation unit 31, the elevator travel state estimation unit 32, the invalid operation analysis unit 56 and the door opening and closing analysis unit 55. The statistical data include at least one of a power consumption statistic data of the first elevator device 200, a number of times the first elevator device 200 is activated and stopped per unit period, and a total travel distance of the first elevator device 200. Therefore, the statistic unit 53 can be used to analyze whether the travel of the first elevator device 200 is reasonable.

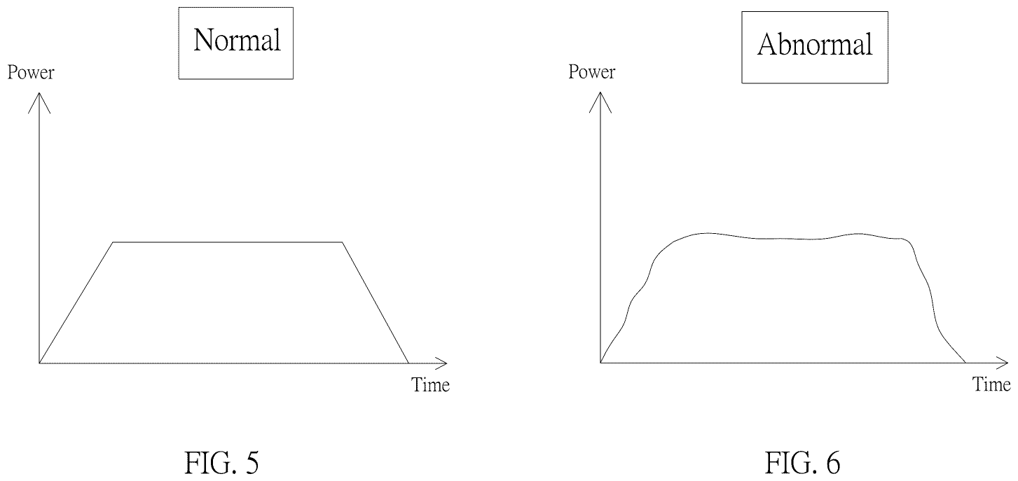

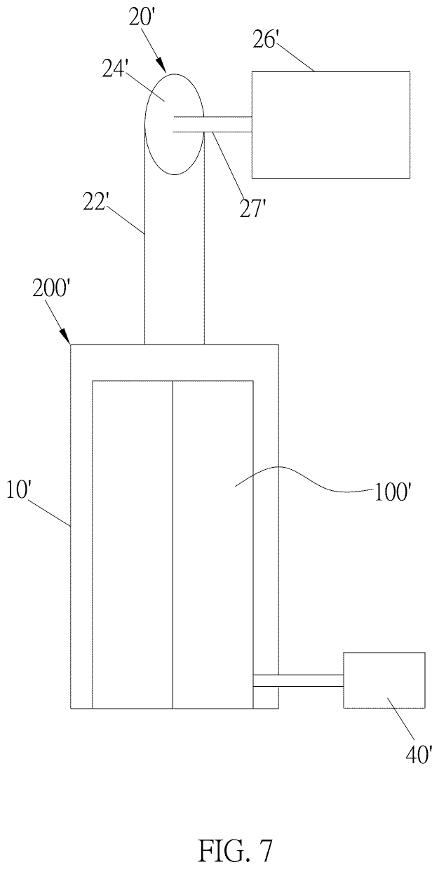

The control processor 50 further includes an abnormal state notification unit 52 connected to the first power reader 30, the first door current meter 45, the ridership estimation unit 31, the elevator travel state estimation unit 32, the invalid operation analysis unit 56, the door opening and closing analysis unit 55 and the statistic unit 53. The abnormal state notification unit 52 serves to determine whether an operation of the first elevator device 200 is in an abnormal state. The abnormal state is determined by a logical comparison set 500 of the abnormal state notification unit 52. The abnormal state is outputted by the abnormal state notification unit 52 for subsequent processing. For example, referring to FIG. 5, when the first elevator device 200 is operating in a normal state in a single operation, the rising, holding, and falling of the output power will form an approximate trapezoidal power distribution. However, referring to FIG. 6, when the first elevator device 200 is operating in an abnormal state in a single operation, the power distribution may have a triangle shape or an irregular shape with excessive shape oscillations, and then the abnormal state notification unit 52 notifies the managers for subsequent processing.

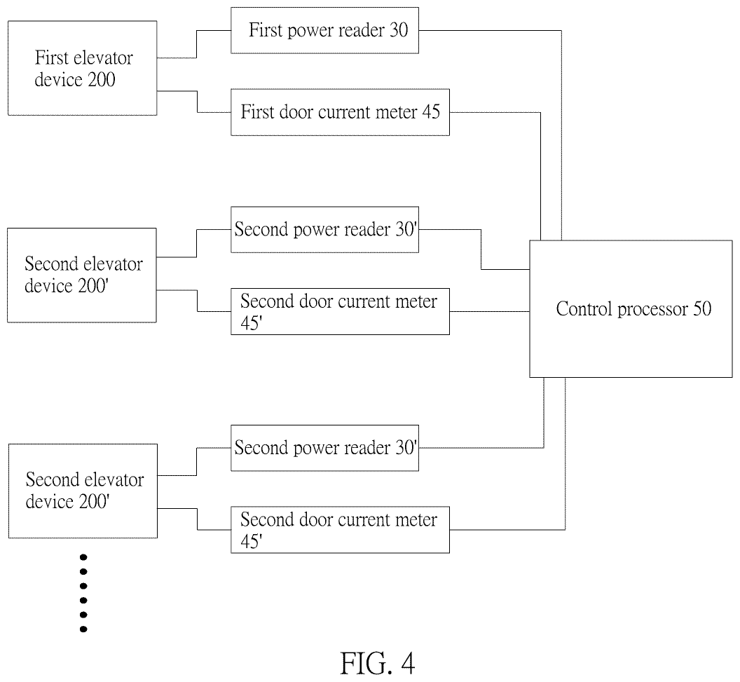

Referring to FIG. 4, the control processor 50 can be connected to a plurality of second power readers 30′and a plurality of second door current meters 45′which are connected to a plurality of second elevator devices 200′. Each of the second elevator devices 200′is connected to a respective one second power reader 30′and a respective one second door current meter 45′. A structure of the first elevator device 200 is identical to that of each of the second elevator devices 200′. A structure of the first power reader 30 is identical to that of each of the second power readers 30′. A structure of the first door current meter 45 is identical to that of each of the second door current meters 45′. The control processor 50 serves to receive and process a plurality of data from the first power reader 30, the second power readers 30′, the first door current meter 45 and the second door current meters 45′for performing a analysis on the first elevator device 200 and the second elevator devices 200′. Therefore, the analysis allows for more effective control of passengers and electricity use in a building with multiple elevator devices.

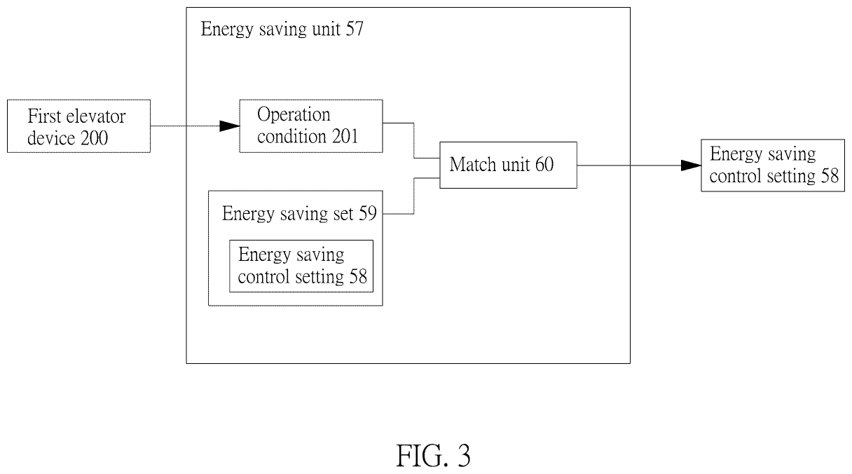

The control processor 50 further includes an energy saving unit 57 is connected to the statistic unit 53 and serves to output an energy saving control setting 58 to the manager for controlling the first elevator device 200 and saving a power consumption of the first elevator device 200 (as shown in FIG. 3). The energy saving unit 57 includes a match unit 60 and a plurality of energy saving sets 59. Each of the energy saving sets 59 has a respective one energy saving control setting 58. The match unit 60 serves to search a matching energy saving set 59 in the energy saving sets 59 based on an operation condition 201 of the first elevator device 200. The energy saving control setting 58 of each of the energy saving sets 59 is set by the manager based on a predetermined control set and a long-term operating situation. The operation condition 201 may be an operation of the first elevator device 200 during a commuting time, which can be used by the match unit 60 to search the energy saving set 59 which matches the operation scheduling of the first elevator device 200 during the commuting time.

The advantages of the present invention are that by using the analysis device of the present invention, the manager can realize whether there are passengers in the elevator device during the entire elevator travel, the load of the elevator device, the number of passengers in the elevator device, and so on. The analysis device further performs an analysis to obtain the elevator power consumption and the operation conditions of different elevator. Therefore, the manager can select an appropriate energy saving setting to control the elevator device and can change the elevator operation scheduling, which solves the operation problems during the rush hour, saves the passing time, increases the transportation capacity and saves the power consumption. The analysis device of the present invention is applicable to ESG (Environmental, social, and governance) construction projects.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An analysis device for analyzing an elevator operation by using a non-invasive electrical data, which serves to analyze an operation of a first elevator device; the analysis device comprising:
a first power reader connected to a main wheel driving motor of an elevator carriage of the first elevator device; the main wheel driving motor serving to drive the elevator carriage moves upwards and downwards; the first power reader including a main wheel current transformer for measuring a single-phase current value of a single-phase electric power of the main wheel driving motor and a single-phase voltage value of the single-phase electric power of the main wheel driving motor; the first power reader serving to calculate a plurality of power operation data based on the single-phase current value and the single-phase voltage value; the power operation data including an instantaneous current, an instantaneous voltage, an instantaneous output power and an instantaneous power consumption; the power operation data being outputted to a control processor to be processed; the control processor being connected to the first power reader; and the first power reader being buckled to a wire of the main wheel driving motor.

2. The analysis device for analyzing the elevator operation by using the non-invasive electrical data as claimed in claim 1, wherein the control processor includes:
a ridership estimation unit connected to the first power reader and serves to estimate a number of passengers of the first elevator device based on the instantaneous output power for obtaining a ridership data per run of the first elevator device; and
an elevator travel state estimation unit connected to the first power reader; the elevator travel state estimation unit serving to calculate speeds, accelerations of the first elevator device at different floors based on a changing of the instantaneous output power to determine a plurality of elevator travel data; the elevator travel data including a running stability of the first elevator device, whether the first elevator device is misaligned when it is activated, and whether the first elevator device has a normal braking function; and the elevator travel data being outputted to inform a manager of the first elevator device for determining whether the first elevator device requires a maintenance or repair.

3. The analysis device for analyzing the elevator operation by using the non-invasive electrical data as claimed in claim 2, wherein the control processor further includes an invalid operation analysis unit is connected to the first power reader and the ridership estimation unit; wherein the invalid operation analysis unit includes a plurality of invalid operation logical condition sets; the power operation data from the first power reader and the ridership of the first elevator device from the ridership estimation unit are inputted to the invalid operation analysis unit for determining an invalid operation data based on the invalid operation logical condition sets; the invalid operation data indicates whether there is at least one invalid operation applied to the first elevator device; and each of the invalid operation logical condition sets is set by an operation record which is performed by the manager of the first elevator device.

4. The analysis device for analyzing the elevator operation by using the non-invasive electrical data as claimed in claim 3, further comprising:
a first door current meter connected to a door driving motor of the first elevator device and the control processor; the door driving motor serving to drive a door of the elevator carriage to open or close the door; the first door current meter including a door current transformer which is installed on a wire of the door driving motor to be measured; the first door current meter serving to measure a door current value data when the door is opened or closed by the door current transformer and to output the door current value data to the control processor; and
wherein the control processor serves to determining a plurality of operation state data of a first elevator device based on the power operation data and the door current value data; and the power operation data and the door current value data form the non-invasive electrical data to be analyzed by the control processor.

5. The analysis device for analyzing the elevator operation by using the non-invasive electrical data as claimed in claim 4, wherein the control processor further includes a door opening and closing analysis unit connected to the first door current meter; and the door opening and closing analysis unit serves to determine a plurality of door operation data of the door based on the door current value data from the first door current meter for analyzing an opening and closing state of the door.

6. The analysis device for analyzing the elevator operation by using the non-invasive electrical data as claimed in claim 5, wherein the door operation data of the door include an opening condition and a closing condition of the door which are determined by a stability of the door current value data, or an opening time and a closing time of the door which are determined by a flow state of the door current value data; and the door operation data is used to determine if the door is operating normally to analyze that if there is an obstruction at the door or there is a passenger caught by the door.

7. The analysis device for analyzing the elevator operation by using the non-invasive electrical data as claimed in claim 5, wherein the control processor further includes a statistic unit connected to the first power reader, the first door current meter, the ridership estimation unit, the elevator travel state estimation unit, the invalid operation analysis unit and the door opening and closing analysis unit; wherein the statistic unit serves to calculate a plurality of statistical data based on a plurality of data of the first elevator device from the first power reader, the first door current meter, the ridership estimation unit, the elevator travel state estimation unit, the invalid operation analysis unit and the door opening and closing analysis unit.

8. The analysis device for analyzing the elevator operation by using the non-invasive electrical data as claimed in claim 7, wherein the statistical data include at least one of a power consumption statistic data of the first elevator device, a number of times the first elevator device is activated and stopped per unit period, and a total travel distance of the first elevator device; and the statistic unit is used to analyze whether the travel of the first elevator device is reasonable.

9. The analysis device for analyzing the elevator operation by using the non-invasive electrical data as claimed in claim 7, wherein the control processor further includes an abnormal state notification unit connected to the first power reader, the first door current meter, the ridership estimation unit, the elevator travel state estimation unit, the invalid operation analysis unit, the door opening and closing analysis unit and the statistic unit; wherein the abnormal state notification unit serves to determine whether the operation of the first elevator device is in an abnormal state; the abnormal state is determined by a logical comparison set of the abnormal state notification unit; and the abnormal state is outputted by the abnormal state notification unit for subsequent processing.

10. The analysis device for analyzing the elevator operation by using the non-invasive electrical data as claimed in claim 7, wherein the control processor is further connected to a plurality of second power readers and a plurality of second door current meters which are connected to a plurality of second elevator devices; wherein each of the second elevator devices is connected to a respective one second power reader and a respective one second door current meter; a structure of the first elevator device is identical to that of each of the second elevator devices; a structure of the first power reader is identical to that of each of the second power readers; a structure of the first door current meter is identical to that of each of the second door current meters; and the control processor serves to receive and process a plurality of data from the first power reader, the second power readers, the first door current meter and the second door current meters for performing a analysis on the first elevator device and the second elevator devices.

11. The analysis device for analyzing the elevator operation by using the non-invasive electrical data as claimed in claim 7, wherein the control processor further includes an energy saving unit connected to the statistic unit and serves to output an energy saving control setting to the manager for controlling the first elevator device and saving a power consumption of the first elevator device; wherein the energy saving unit includes a match unit and a plurality of energy saving sets; each of the energy saving sets has a respective one energy saving control setting; and the match unit serves to search a matching energy saving set in the energy saving sets based on an operation condition of the first elevator device.
